(19) United States
(12) Patent Application Publication
(10) Pub. No.: US 2020/0118201 A1
(43) Pub. Date: Apr. 16, 2020

(54) RENTAL MANAGEMENT APPARATUS, METHOD OF MANAGING RENTAL, AND COMPUTER READABLE RECORDING MEDIUM

(71) Applicants: TOYOTA JIDOSHA KABUSHIKI KAISHA, Toyota-shi (JP); NOMURA RESEARCH INSTITUTE, LTD., Tokyo (JP)

(72) Inventors: Daiki KANEICHI, Nisshin-shi (JP); Naoya SUGITA, Chiyoda-ku (JP)

(73) Assignees: TOYOTA JIDOSHA KABUSHIKI KAISHA, Toyota-shi (JP); NOMURA RESEARCH INSTITUTE, LTD., Tokyo (JP)

(21) Appl. No.: 16/587,796

(22) Filed: Sep. 30, 2019

(30) Foreign Application Priority Data
Oct. 10, 2018 (JP) 2018-191975

(51) Int. Cl. G06Q 30/06; G06Q 50/30

(52) U.S. Cl. CPC G06Q 30/0645; H04L 67/42; G06Q 50/30

(57) ABSTRACT

A rental management apparatus for managing rental of moving objects capable of establishing communication with an external device includes a processor including hardware. The processor is configured to: acquire: credibility information including credibility which is a numerical form of credit of a user carrying a terminal; positional information about the moving objects; and positional information about the terminal; and transmit, to the terminal, permission information for permitting rental of at least one of the moving objects present in a predetermined area covering a position of the terminal when the credibility included in the credibility information about the user is equal to or greater than a prescribed value and the moving objects are present in the predetermined area.

The present application claims priority to and incorporates by reference the entire contents of Japanese Patent Application No. 2018-191975 filed in Japan on Oct. 10, 2018.

### BACKGROUND

The present disclosure relates to a rental management apparatus, a method of managing rental, and a computer readable recording medium.

JP 2012-164210 A discloses a technique for differentiating service to be provided to a user in car-sharing service, by acquiring information about travel of a vehicle and scoring a degree to which a user's manner of driving gives consideration to natural environment based on the information about travel of a vehicle. In this technique, it is evaluated whether or not a user's manner of driving gives consideration to natural environment, and details of differentiated service, such as a discount of fees for car-sharing service, are determined based on a result of scoring. In this regard, items for scoring are an amount of consumed fuel, a distance traveled, an average acceleration, and the like, for example.

As service which can be provided to a user while being differentiated based on a result of scoring described above, service which simplifies various procedures for using a moving object in using a moving object such as a vehicle, is conceivable. Specifically, in service such as car-sharing service in which a user rents a moving object, a user has to follow various procedures in order to rent a moving object. Such procedures are procedures which are completed by use of an application of a terminal apparatus carried by a user, or by a user's access to a website of a company via the internet, and a process therefor is complicated. Thus, in order to improve convenience in service for rental of a moving object, it is desired to simplify various procedures at a time when a user who shall receive differentiated service rents a moving object.

There is a need for a rental management apparatus, a method of managing rental, and a computer readable recording medium which may improve convenience in service for rental of a moving object at a time when a user who shall receive differentiated service rents a moving object.

### SUMMARY

According to one aspect of the present disclosure, there is provided a rental management apparatus for managing rental of moving objects capable of establishing communication with an external device, the rental management apparatus including a processor including hardware, the processor being configured to: acquire: credibility information including credibility which is a numerical form of credit of a user carrying a terminal; positional information about the moving objects; and positional information about the terminal; and transmit, to the terminal, permission information for permitting rental of at least one of the moving objects present in a predetermined area covering a position of the terminal when the credibility included in the credibility information about the user is equal to or greater than a prescribed value and the moving objects are present in the predetermined area.

The above and other objects, features, advantages and technical and industrial significance of this disclosure will be better understood by reading the following detailed description of exemplary embodiments of the disclosure, when considered in connection with the accompanying drawings.

### BRIEF DESCRIPTION OF THE DRAWINGS

FIG. 1 is a schematic view illustrating a rental management system to which a rental management apparatus according to an exemplary embodiment may be applied;

FIG. 2 is a block diagram schematically illustrating a configuration of the rental management apparatus illustrated in FIG. 1 according to the exemplary embodiment;

FIG. 3 is a block diagram schematically illustrating a configuration of a credit evaluation server illustrated in FIG. 1;

FIG. 4 is a block diagram schematically illustrating a configuration of a data server illustrated in FIG. 1;

FIG. 5 is a block diagram schematically illustrating a configuration of a vehicle illustrated in FIG. 1;

FIG. 6 is a block diagram schematically illustrating a configuration of a user terminal apparatus illustrated in FIG. 1;

FIG. 7 is a flow chart for explaining a rental management method according to the exemplary embodiment;

FIG. 8 is a schematic view for explaining the rental management method according to the exemplary embodiment;

FIG. 9 is a flow chart for explaining a rental management method according to an exemplary embodiment; and

FIG. 10 is a schematic view for explaining the rental management method according to the exemplary embodiment.

### DETAILED DESCRIPTION

Hereinafter, exemplary embodiments will be described with reference to the drawings. It is noted that in all of the drawings referred to in the following exemplary embodiments, the same or similar parts will be denoted by the same reference signs. Also, the present disclosure is not limited to the exemplary embodiments described below.

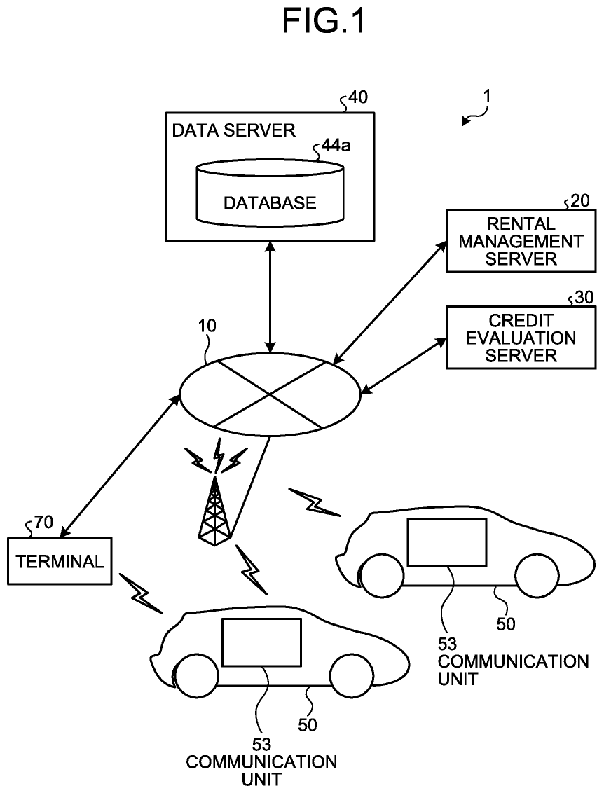

First, a rental management system according to an exemplary embodiment will be described. FIG. 1 is a schematic view illustrating a rental management system 1 according to the exemplary embodiment. As illustrated in FIG. 1, the rental management system 1 includes a rental management server 20, a credit evaluation server 30, a data server 40, a vehicle 50 provided with a communication unit 53, and a user terminal apparatus 70 which may communicate with each other via a network 10.

The network 10 is formed of the internet network, a mobile-phone network, or the like. The network 10 is a public communications network such as the internet, for example, and may include the other communications networks such as a wide area network (WAN), a network for a telephone such as a mobile phone, or a wireless communications network such as WiFi (registered trademark).

The rental management server 20 serving as a rental management apparatus is a management server which is owned by a rental service company such as a car-sharing service company that rents out the vehicle 50, for example. That is, the rental management server 20 manages rental of the vehicle 50.

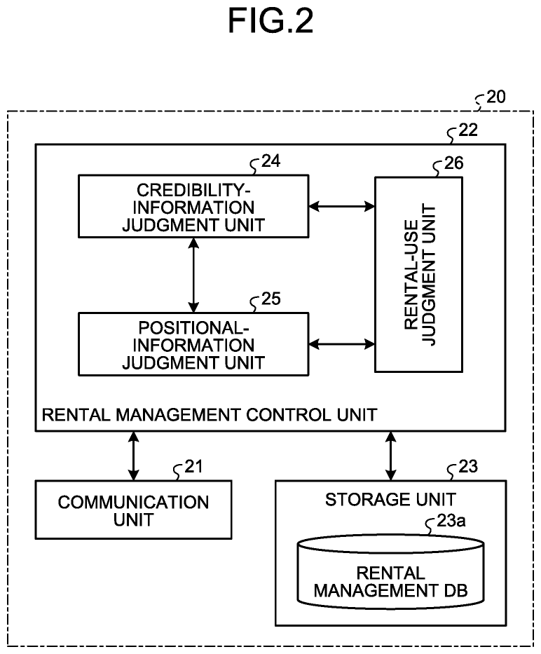

FIG. 2 is a block diagram schematically illustrating a configuration of the rental management server 20. As illustrated in FIG. 2, the rental management server 20 has a configuration of a general computer which may establish communication via the network 10. The rental management server 20 includes a communication unit 21, a rental management control unit 22, and a storage unit 23 in which a rental management database 23a is stored. The rental management control unit 22 includes a credibility-information judgment unit 24, a positional-information judgment unit 25, and a rental-use judgment unit 26.

The communication unit 21 is a local-area-network (LAN) interface board, a wireless communications circuit for wireless communications, or the like, for example. A LAN interface board or a wireless communications circuit is connected to the network 10 which is a public communications network such as the internet. The communication unit 21 is connected to the network 10, and communicates with the credit evaluation server 30, the data server 40, the vehicle 50, and the user terminal apparatus 70.

The communication unit 21 receives various kinds of information such as vehicle identifying information, running information, and vehicular information which are specific to the vehicle 50, and sends an instruction signal for the vehicle 50, from and to each of the vehicles 50. Vehicle identifying information includes information by which each of the vehicles 50 may be individually identified. Running information includes positional information, and may further include information regarding running of the vehicle 50, such as speed information, acceleration information, distance-travelled information, and travelling-time information. Vehicular information includes information relating to presence or absence of a user who rents, and is riding in, the vehicle 50. In a case where a user who rents, and is riding in, the vehicle 50 is present, vehicular information includes also user identifying information about the user who is riding in the vehicle 50, or the like. Vehicular information may further include various kinds of information (which will be hereinafter referred to as vehicle state information) about a state of the vehicle 50 such as a state of charge (SOC) of a battery, a remaining amount of fuel, and a condition inside a vehicle. However, information included in vehicular information is not necessarily limited to the above-described information.

The communication unit 21 serving as an information acquisition unit receives information (which will be hereinafter referred to as credibility information) regarding credibility of a user carrying the user terminal apparatus 70, and sends a request signal (which will hereinafter be referred to as a credibility request signal) which requests sending of credibility information about a certain user, from and to the credit evaluation server 30. Credibility information about a user includes information about a user's credit which is converted into a numerical form as credibility. The communication unit 21 receives various kinds of information included in big data or the like in a database form, and sends a request signal which requests sending of predetermined information, from and to the data server 40. The communication unit 21 sends information to the user terminal apparatus 70 owned by a user, and receives user identifying information and various kinds of information for identifying a user from the user terminal apparatus 70 when the vehicle 50 is used.

The rental management control unit 22, specifically speaking, includes a processor such as a central processing unit (CPU), a digital signal processor (DSP), or a field-programmable gate array (FPGA), and a main storage unit such as a random access memory (RAM) or a read only memory (ROM), which are not illustrated in the drawings. The storage unit 23 is formed of a storage medium selected from an erasable programmable ROM (EPROM), a hard disk drive (HDD), a removable medium, and the like. It is noted that a removable medium is a disk storage medium such as a universal serial bus (USB) memory, a compact disk (CD), a digital versatile disk (DVD), or a Blu-ray (registered trademark) disk (BD), for example. In the storage unit 23, an operating system (OS), various programs, various tables, various databases, and the like may be stored. The rental management control unit 22 loads a program stored in the storage unit 23 into a workspace of the main storage unit and executes a program, to control respective components through execution of a program. Thus, the rental management control unit 22 may fulfill functions of the credibility-information judgment unit 24, the positional-information judgment unit 25, and the rental-use judgment unit 26 which serve a predetermined purpose.

The credibility-information judgment unit 24 acquires credibility information sent from the credit evaluation server 30 which will be later described, via the communication unit 21, and inputs credibility information to the rental-use judgment unit 26. The positional-information judgment unit 25 acquires a user's positional information sent from the user terminal apparatus 70 which will be later described, via the communication unit 21, and inputs a user's positional information to the rental-use judgment unit 26. Alternatively, the credibility-information judgment unit 24 and the positional-information judgment unit 25 may be caused to operate cooperatively so that credibility information and positional information about a user are fed to the rental-use judgment unit 26 while being associated with each other. The rental-use judgment unit 26 judges whether or not a certain user's credibility input from the credibility-information judgment unit 24 is equal to or greater than a predetermined value. If a user's credibility is equal to or greater than a predetermined value and positional information about the user terminal apparatus 70 indicates that the apparatus is in a service area, the rental-use judgment unit 26 sends an electronic key serving as a use-permitting signal that permits a ride in at least one vehicle 50 located in a predetermined area, to the user terminal apparatus 70.

The storage unit 23 includes a rental management database 23a formed of a relational database (RDB), for example. It is noted that each of databases (DB) which will be described below is constructed by management of data stored in the storage unit, by a program which is executed by the above-described processor in a database management system (DBMS).

In the rental management database 23a, user identifying information and each of various kinds of information or the like (which will hereinafter be also referred to as user selection information) which is input or selected by a user and is necessary for renting the vehicle 50 are stored while corresponding to each other and being searchable. User selection information includes information about an item selected by each user, information relating to a start or an end of a user's rental of the vehicle 50, and information about basic rental fees or the like which are set for each user. In the rental management database 23a, vehicle identifying information and each of vehicular information, running information, and the like are stored while corresponding to each other and being searchable.

User identifying information and vehicle identifying information are stored into the rental management database 23a while being placed in a searchable state when they are assigned to a user and the vehicle 50, respectively. User identifying information includes various kinds of information for identifying individual users from each other. User identifying information is a user ID or the like by which an individual user may be identified, and is recorded while corresponding to information specific to a user, such as a user's name or address, positional information such as a longitude and a latitude indicating a user's position, or the like. In other words, user identifying information includes information necessary for accessing the rental management server 20 in sending information regarding a user. For example, when the user terminal apparatus 70 sends predetermined information such as user selection information, together with user identifying information, to the rental management server 20, the rental management server 20 stores the predetermined information into the rental management database 23a of the storage unit 23 while establishing correspondence between the predetermined information and user identifying information and making the predetermined information searchable. Likewise, vehicle identifying information includes various kinds of information for identifying individual vehicles 50 from each other. When the vehicle 50 sends predetermined information such as positional information or vehicular information, together with vehicle identifying information, to the rental management server 20, the rental management server 20 stores the predetermined information into the rental management database 23a while establishing correspondence between the predetermined information and vehicle identifying information and making the predetermined information searchable.

More specifically, in the rental management database 23a, vehicle identifying information and information about additional rental fees which are set for each of the vehicles 50 and are charged per unit time or unit distance travelled, for example, are stored while corresponding to each other. The rental-use judgment unit 26 searches out vehicle identifying information, user identifying information, basic rental fees charged to a user who uses service, additional rental fees charged based on running information of the vehicle 50, and running information about the vehicle 50, from the rental management database 23a, to generate billing information about a user regarding rental of the vehicle 50. The rental-use judgment unit 26 sends generated billing information to the user terminal apparatus 70 of a user, to thereby inform a user of rental fees.

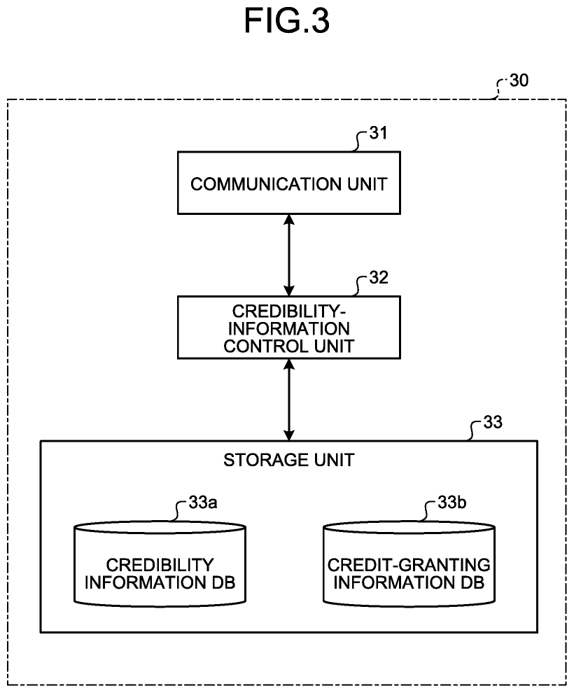

The credit evaluation server 30 serving as a credit evaluation apparatus receives various kinds of information (which will be hereinafter referred to as credit evaluation information) which are necessary for evaluating a user's credit, from the rental management server 20 or the data server 40. The credit evaluation server 30 generates credibility information by converting a user's credit into a numerical form depending on credibility defined by a predetermined function in which received credit evaluation information is an input value. Credibility is obtained by conversion of a user's credit into a numerical form in accordance with a predetermined rule. FIG. 3 is a block diagram schematically illustrating a configuration of the credit evaluation server 30. As illustrated in FIG. 3, the credit evaluation server 30 has a configuration of a general computer which may establish communication via the network 10. The credit evaluation server 30 includes a communication unit 31, a credibility-information control unit 32, and a storage unit 33.

The communication unit 31, being configured similarly to the above-described communication unit 21, is connected to the network 10 and communicates with at least the rental management server 20 and the data server 40. It is noted that the communication unit 31 may be configured so as to establish communication with the vehicle 50 or the user terminal apparatus 70 as needed. The communication unit 31 sends the above-described credibility information to the rental management server 20, receives a credibility request signal or credit evaluation information from the rental management server 20, and receives credit evaluation information from the data server 40.

The credibility-information control unit 32 and the storage unit 33 are physically similar to the above-described rental management control unit 22 and the storage unit 23, respectively. In the storage unit 33, credibility information database 33a and credit-granting information database 33b are stored. In the credibility information database 33a, user identifying information and each of various kinds of information including credibility information about each user are stored while corresponding to each other and being searchable. Credit evaluation information is sent from the rental management server 20 or the data server 40 to the credit evaluation server 30 at a time after a user uses service with the vehicle 50, or the like time, for example. The credibility-information control unit 32 of the credit evaluation server 30 calculates credibility in a numerical form based on received credit evaluation information, stores the credibility in a numerical form as credibility information into the credibility information database 33a, and updates the database 33a. In the credit-granting information database 33b, user identifying information and information (credit-granting information) regarding a user's transaction on credit, such as a credit card or loan, are stored while corresponding to each other and being searchable. In a case where a user conducts transaction on credit or the like, for example, the credibility-information control unit 32 of the credit evaluation server 30 stores credit-granting information into the credit-granting information database 33b while making the credit-granting information searchable, and updates the database 33b. Also, a place of the credit-granting information database 33b is not limited to the credit evaluation server 30. That is, the credit-granting information database 33b may be provided in the data server 40 or a different server (not illustrated), other than the credit evaluation server 30, and may be designed so that the credit-granting information database 33b stored in a different server may be accessed via the network 10 as needed.

Credit evaluation information about a user who uses service provided in the vehicle 50 includes moving-object information and third-party evaluation information. Moving-object information includes use-state information regarding the vehicle 50 during use of service by a user, and moving-object condition information which indicates a condition of the vehicle 50 after a user uses service. Use-state information includes information regarding a behavior of the vehicle 50 in driving and information regarding a behavior of a user who is a driver of the vehicle 50, in driving. Moving-object information includes information regarding a condition of the vehicle 50 after a user uses service with the vehicle 50. Third-party evaluation information includes information regarding evaluation which is made by the third party other than a user after the user uses service. In the credit evaluation server 30, a user's credibility is calculated in a numerical form based on the above-described use-state information, moving-object condition information, third-party evaluation information, and the like, so that credit of a user is evaluated.

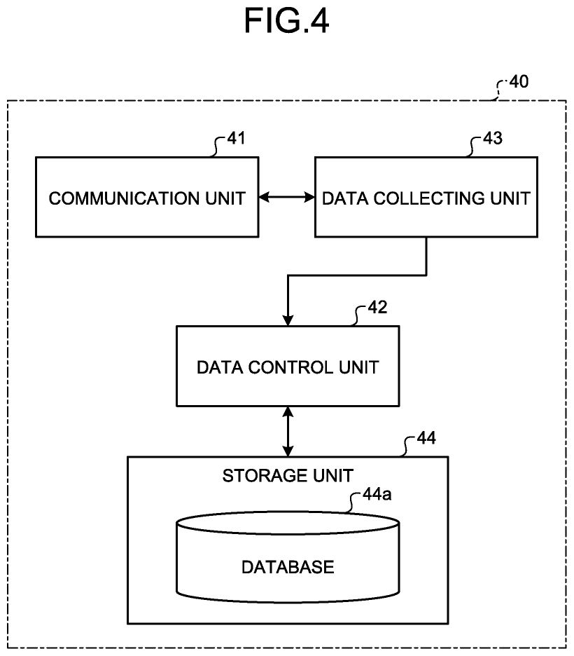

The data server 40 performs a data-collecting process of collecting various kinds of information output from the vehicle 50 serving as a moving object having a communications function. FIG. 4 is a block diagram schematically illustrating a configuration of the data server 40. As illustrated in FIG. 4, the data server 40 has a configuration which may establish communication via the network 10. The data server 40 includes a communication unit 41, a data control unit 42, a data collecting unit 43, and a storage unit 44. The communication unit 41 is physically similar to the above-described communication units 21 and 31. The communication unit 41 makes connections with the network 10, and communicates with the rental management server 20, the credit evaluation server 30, and the vehicle 50. The communication unit 41 may communicate with the user terminal apparatus 70.

The communication unit 41 selects at least a part of the above-described user identifying information, vehicle identifying information, user selection information, vehicular information, running information, credibility information, and credit evaluation information, and sends/receives the selected information to/from the rental management server 20 and the credit evaluation server 30. The communication unit 41 collects running information such as positional information, speed information, acceleration information, and running-plan information from the vehicle 50, based on a command signal provided from the data collecting unit 43. It is noted that information sent/received by the communication unit 41 is not limited to the above-described kinds of information. Also, in a case where information is collected from a moving object having a communications function, other than the vehicle 50, a kind and an item of information to be collected may be arbitrarily determined depending on a kind of a moving object.

The data control unit 42 and the storage unit 44 are physically similar to the above-described rental management control unit 22 and the storage unit 23, respectively. In the storage unit 44, various kinds of information ever collected from the rental management server 20, the credit evaluation server 30, and the vehicle 50 via the network 10 are stored, as database 44a including big data, for example. It is noted that various kinds of information may be collected from each of the user terminal apparatuses 70, to be stored into the database 44a.

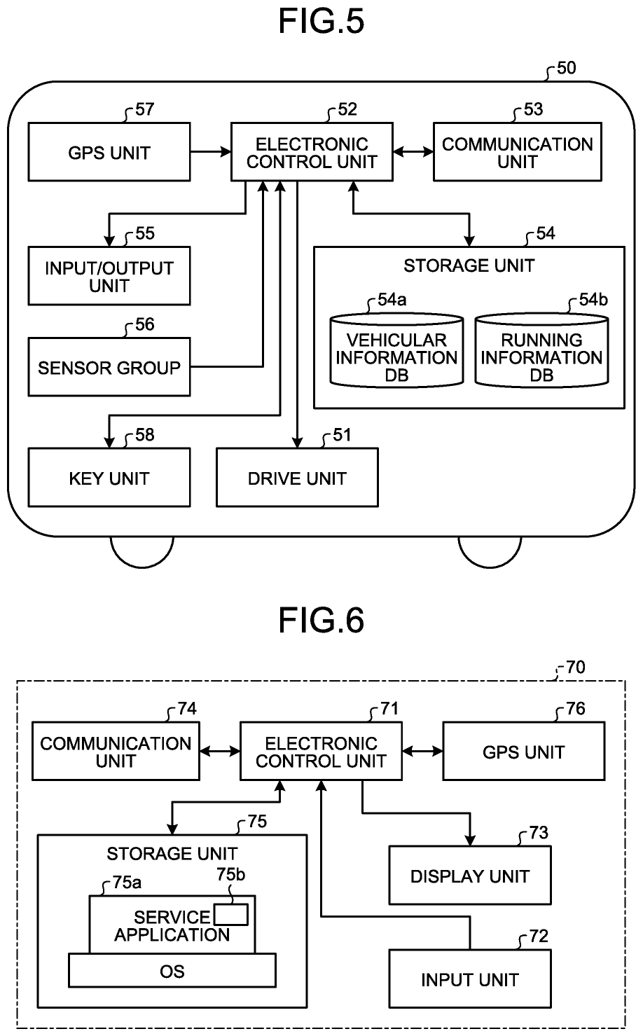

The vehicle 50 serving as a moving object is a vehicle which is caused to travel by a driver's driving operation, or an autonomously-travelling vehicle which is configured so as to be capable of autonomously travelling in accordance with an instruction for running as given. FIG. 5 is a block diagram schematically illustrating a configuration of the vehicle 50. As illustrated in FIG. 5, the vehicle 50 includes a drive unit 51, an electronic control unit 52, the communication unit 53, a storage unit 54, an input/output unit 55, a sensor group 56, a GPS unit 57, and a key unit 58.

The drive unit 51 is a conventionally-known drive unit necessary for travel of the vehicle 50. More specifically, the vehicle 50 includes an engine serving as a drive source, and the engine is configured so that it may produce electric power with the use of an electric motor, or the like, being driven by combustion of fuel. A chargeable battery is charged with produced electric power. Further, the vehicle 50 includes a drive transmission mechanism which transmits drive force of the engine, and a drive wheel for travelling.

The electronic control unit 52 and the storage unit 54 are physically similar to the above-described rental management control unit 22 and the storage unit 23, respectively. The electronic control unit 52 controls operations of respective components mounted in the vehicle 50 in a centralized fashion. The communication unit 53 is formed of a data communication module (DCM), for example, which communicates with the rental management server 20 and the data server 40 by wireless communication via the network 10. The storage unit 54 includes a vehicular information database 54a and a running information database 54b. In the vehicular information database 54a, various kinds of information including a state of charge of a battery, a remaining amount of fuel, a current position, and the like are stored while being updatable. In the running information database 54b, various kinds of information including running information provided from the rental management server 20 are stored while being updatable.

The input/output unit 55 is formed of a touch-panel display, a speaker microphone, and the like. As an output unit, the input/output unit 55 is configured so as to be capable of providing predetermined information to the outside by displaying characters or graphics on a screen of a touch-panel display or by outputting a voice from a speaker microphone under control of the electronic control unit 52. Also, as an input unit, the input/output unit 55 is configured so as to be capable of inputting predetermined information to the electronic control unit 52 by having a user or the like operate a touch-panel display or by having a user or the like give voice toward a speaker microphone.

The sensor group 56 is formed of a sensor for travel of the vehicle 50, such as a vehicle-speed sensor or an acceleration sensor, a car-interior sensor which may detect various states of a car interior, for example, an imaging apparatus such as an imaging camera, for example, and the like. The GPS unit 57 serving as a positional-information acquisition unit of the vehicle 50 receives radio waves from a global positioning system (GPS) satellite (not illustrated) and detects a position of the vehicle 50. A detected position of the vehicle 50 is stored into the vehicular information database 54a, as positional information in vehicular information while being searchable. It is noted that a method obtained by combination of light detection and ranging, laser imaging detection and ranging (LiDAR) with a three-dimensional digital map may be employed as a method for detecting a position of the vehicle 50.

The user terminal apparatus 70 serving as a terminal is operated by a user. The user terminal apparatus 70 sends various kinds of information such as user information including user identifying information and user selection information, to the rental management server 20, through a phone call using various data and voices with a communications application, for example. The user terminal apparatus 70 is configured so as to be capable of receiving various kinds of information such as running-plan information, an allocation approving signal, data of an electronic key, and the like, from the rental management server 20. FIG. 6 is a block diagram schematically illustrating a configuration of the user terminal apparatus 70 illustrated in FIG. 1.

As illustrated in FIG. 6, the user terminal apparatus 70 includes an electronic control unit 71, an input unit 72, a display unit 73, a communication unit 74, a storage unit 75, and a GPS unit 76 which are connected so as to establish communication with each other. The electronic control unit 71, the communication unit 74, and the storage unit 75 are physically similar to the above-described rental management control unit 22, the communication unit 21, and the storage unit 23, respectively. The GPS unit 76 is physically similar to the above-described GPS unit 57.

The electronic control unit 71 may execute various programs stored in the storage unit 75, and store various tables, various databases, and the like into the storage unit 75. The electronic control unit 71 loads an OS or a service application 75a stored in the storage unit 75 into a workspace of a main storage unit, and executes it, to control operations of the input unit 72, the display unit 73, the communication unit 74, the storage unit 75, and the GPS unit 76 in a centralized fashion. A locking/unlocking request program 75b in the form of a software development kit (SDK), for example, is installed in the service application 75a. The locking/unlocking request program 75b is executed by the service application 75a in the user terminal apparatus 70 and authentication is performed between the user terminal apparatus 70 and the key unit 58 based on BLE authentication information, for example, so that the vehicle 50 may be locked and unlocked. It is noted that various methods which are conventionally known may be employed for locking and unlocking the vehicle 50 through communication between the user terminal apparatus 70 and the key unit 58.

The communication unit 74 sends/receives various kinds of information such as user identifying information, user selection information, and voice data, to/from an external server such as the rental management server 20, via the network 10. The storage unit 75 is configured so that user identifying information may be stored therein. The GPS unit 76 serving as a positional-information acquisition unit of a terminal detects a position of the user terminal apparatus 70 through communication with the GPS satellite (not illustrated). A detected position is sent as positional information about a user in user identifying information, to the rental management server 20 or the data server 40 via the network 10.

The input unit 72 is formed of a touch-panel keyboard which is incorporated in a keyboard or the display unit 73, and detects a touching operation on a display panel, or is formed of a voice inputting device which allows a call to the outside to be made. In this regard, a call to the outside includes not only a call to another user terminal apparatus 70, but also a call to an operator being stationed at the rental management server 20 or an artificial intelligence system, or the like, for example. The display unit 73 is formed of an organic EL panel, a liquid-crystal display panel, or the like, for example, and provides information to the outside by displaying characters or graphics on a display panel. It is noted that the input unit 72 and the display unit 73 may be configured similarly to the above-described input/output unit 55. More specifically, as the user terminal apparatus 70, various kinds of apparatuses that a user may carry, such as a mobile phone like a smartphone, or an information terminal of tablet type or the like may be used.

Next, a rental management method which is performed by the rental management server 20 in the rental management system 1 configured in the above-described manner will be described. It is noted that regarding the following rental management method, description will be made by taking a case where a user U1 rents the vehicle 50 by starting the service application 75a provided by a car-sharing service company, as an example. Also, though information is sent and received via the network 10 in the following description, description in this respect on each occasion will be omitted.

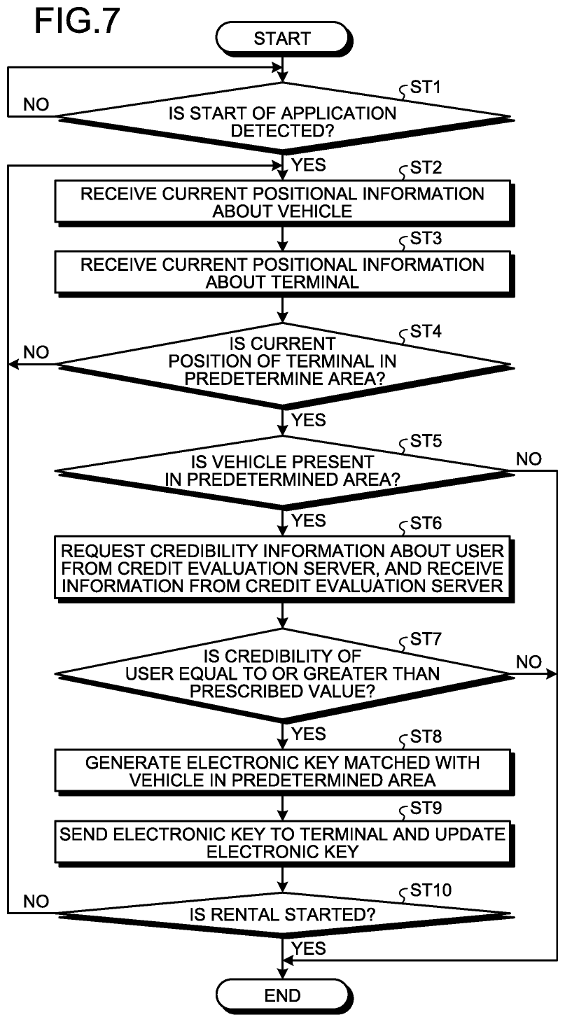

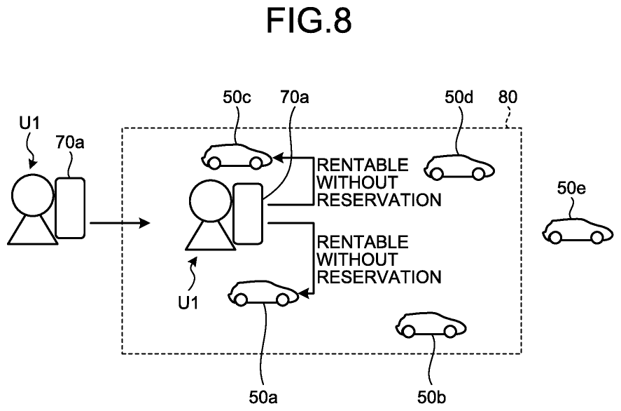

First, a rental management method will be described. FIGS. 7 and 8 are a flow chart and a schematic view, respectively, for explaining the rental management method. The following description will be made in accordance with the flow chart in FIG. 7, while referring to FIG. 8 as appropriate.

Specifically, as illustrated in FIGS. 7 and 8, in step ST1, the positional-information judgment unit 25 of the rental management server 20 judges whether or not the service application 75a is in a started state in a user terminal apparatus 70a. If the service application 75a is in the started state, information relating to a start is sent from the user terminal apparatus 70a to the rental management server 20. It is noted that the service application 75a may be the started state in either foreground processing or background processing. The rental management server 20 repeatedly performs step ST1 while information relating to a start is not received (step ST1: No).

In a case where the positional-information judgment unit 25 receives information relating to a start of the service application 75a in a user terminal apparatus 70a (step ST1: Yes), the process proceeds to step ST2. In step ST2, the positional-information judgment unit 25 receives information about a current position (which will be hereinafter referred to as current positional information) from each of vehicles 50a, 50b, 50c, 50d, and 50e. It is noted that the vehicles 50a to 50e are vehicles which are owned or managed by a car-sharing service company managing the rental management server 20, for example, but they are not necessarily limited to vehicles which are owned or managed by a car-sharing service company. Subsequently, in step ST3, the positional-information judgment unit 25 receives current positional information about the user terminal apparatus 70a of the user U1 illustrated in FIG. 8. In this regard, an order of steps ST2 and ST3 is not limited to any specific order, and those steps may be performed in a reverse order or in parallel. Also, steps ST2 and ST3 may be performed at predetermined time intervals regardless of whether or not it is judged that the service application 75a is started in step ST1.

Thereafter, in step ST4, the positional-information judgment unit 25 judges whether or not a current position included in current positional information about the user terminal apparatus 70a carried by the user U1 is in a closed area 80 which is a predetermined area determined previously. If the positional-information judgment unit 25 judges that a current position of the user terminal apparatus 70 of the user U1 is not in the closed area 80 (step ST4: No), the process returns to step ST2. On the other hand, if the positional-information judgment unit 25 judges that a current position of the user terminal apparatus 70 of the user U1 is in the closed area 80 (step ST4: Yes), the process proceeds to step ST5.

In step ST5, the positional-information judgment unit 25 judges whether or not at least one vehicle 50 is present in the closed area 80. If the positional-information judgment unit 25 judges that the vehicle 50 is not present in the closed area 80 (step ST5: No), the rental management process which is a process of renting out the vehicle 50 is finished. On the other hand, if the positional-information judgment unit 25 judges that the vehicle 50 is present in the closed area 80 (step ST5: Yes), the process proceeds to step ST6.

In step ST6, the credibility-information judgment unit 24 sends a credibility request signal regarding the user U1 to the credit evaluation server 30, and receives credibility information about the user U1 from the credit evaluation server 30. Subsequently, in step ST7, the credibility-information judgment unit 24 judges whether or not credibility of the user U1 is equal to or greater than a prescribed value which is determined previously. If credibility of the user U1 is less than a prescribed value (step ST7: No), the rental management process which is a process of renting out the vehicle 50 is finished. On the other hand, if credibility of the user U1 is equal to or greater than a prescribed value (step ST7: Yes), the process proceeds to step ST8.

It is noted that steps ST6 and ST7 may be performed before steps ST2 and ST3. In this case, if the rental management server 20 receives credibility information about the user U1 and a requirement that credibility included in credibility information is equal to or greater than a prescribed value is satisfied (step ST7: Yes), current positional information in steps ST2 and ST3 is received.

In step ST8, the rental-use judgment unit 26 generates an electronic key serving as permission information with which at least one vehicle 50a present in the closed area 80 may be unlocked. It is noted that an electronic key with which all of the vehicles 50a to 50d may be unlocked may be generated. In a case where an electronic key with which all of the vehicles 50a to 50d may be unlocked is generated, electronic keys which match the vehicles 50a to 50d, respectively, are generated. Alternatively, only one common electronic key with which the vehicles 50a to 50d present in the closed area 80 may be unlocked and the vehicle 50e present outside the closed area 80 cannot be unlocked may be generated. Thereafter, in step ST9, the rental management control unit 22 of the rental management server 20 encrypts a generated electronic key, and sends the electronic key to the user terminal apparatus 70a of the user U1.

Generation of an electronic key in step ST8 may be accomplished in the data server 40, for example, which is a server different from the rental management server 20. In this case, the rental management server 20 sends a request signal for generation of an electronic key to the data server 40. The data server 40, which receives a request signal for generation, generates an encrypted electronic key which matches at least one vehicle in the closed area 80, for example, the vehicle 50a located closest to the user U1. It is noted that an encrypted electronic key which matches all of the vehicles 50a to 50d may be generated. Thereafter, in step ST9, the data server 40 sends an encrypted electronic key to the user terminal apparatus 70 by way of the rental management server 20.

In the user terminal apparatus 70 which receives an electronic key in the above-described manner, an earlier electronic key stored in the storage unit 75 is updated to the newest electronic key. Thereafter, the process proceeds to step ST10.

In step ST10, the rental-use judgment unit 26 judges whether or not the user U1 rents the vehicle 50. More specifically, the rental-use judgment unit 26 receives at least one set of information, out of a set of vehicle identifying information and vehicular information which are sent from the vehicle 50a and a set of user identifying information and user selection information which are sent from the user terminal apparatus 70a, for a predetermined time via the communication unit 21. In a case where the user U1 unlocks the vehicle 50a in the closed area 80 by performing authentication such as BLE authentication, for example, using the locking/unlocking request program 75b in the user terminal apparatus 70a, user identifying information about the user U1 and information relating to a start of rental of the vehicle 50a by the user U1 are added to vehicular information while corresponding to each other. Accordingly, the rental-use judgment unit 26 may judge whether or not the user U1 rents the certain vehicle 50a, based on vehicle identifying information and vehicular information which are received. It is noted that vehicle identifying information about the vehicle 50a to be rented by the user U1 and information relating to a start of rental of the vehicle 50a by the user U1 may be added to user selection information while corresponding to each other. In this case, the rental-use judgment unit 26 may judge whether or not rental of the certain vehicle 50a by the user U1 is started, based on user identifying information and user selection information which are received.

If information relating to a start of rental of the vehicle 50 by the user U1 is not included in vehicular information or user selection information after a predetermined time elapses, the rental-use judgment unit 26 judges that rental of the vehicle 50 by the user U1 is not started (step ST10: No), and the process returns to step ST2. It is noted that also in a case where steps ST6 and ST7 are performed before step ST2, when it is judged that rental of the vehicle 50 is not started in step ST9 (step ST10: No), the rental management process returns to step ST2. The above-described steps ST2 to ST10 are repeatedly performed at predetermined periods until rental of the vehicle 50 by the user U1 is started. In the above-described manner, the rental management process in the rental management server 20 is performed.

If information relating to a start of rental of the vehicle 50 in the closed area 80 is included in vehicular information or user selection information which is received by the rental management server 20, the rental-use judgment unit 26 judges that rental of a specific vehicle 50a, for example, is started (step ST10: Yes). When rental of the vehicle 50a by the user U1 carrying the user terminal apparatus 70a is started, the rental management process in the rental management server 20 is finished.

By the above-described rental management method, in car-sharing service for renting out the vehicle 50, every user that has credibility equal to or greater than a prescribed value and carries the user terminal apparatus 70 may rent the vehicle 50 which is located in the closed area 80 being determined previously and is owned or managed by a car-sharing service company, for example, without following various procedures necessary for rental by a user himself. Accordingly, a highly-credible user does not need to perform a complicated process and may ride in the vehicle 50 that he desires to ride, and thus, convenience in car-sharing service to a highly-credible user may be improved.

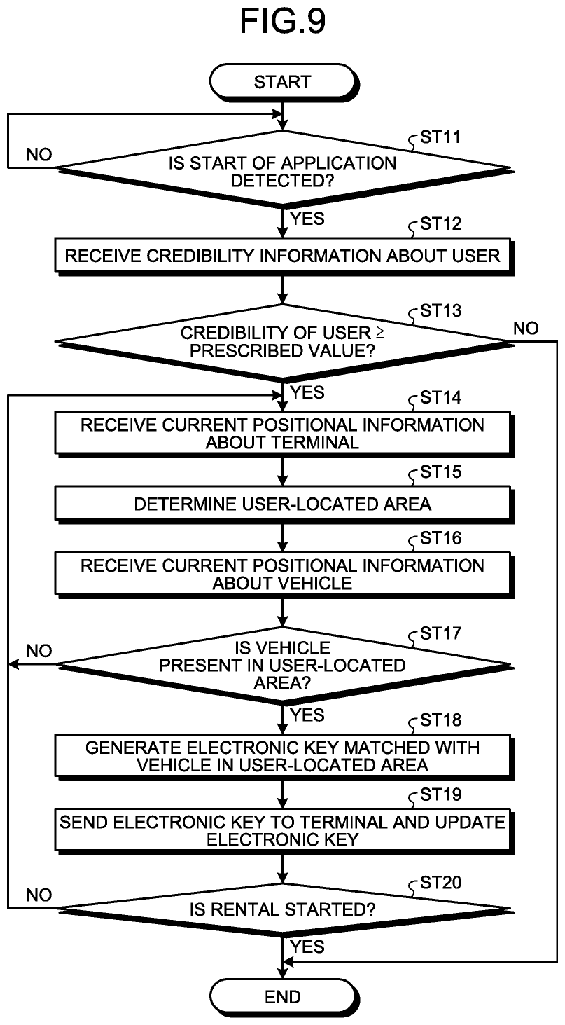

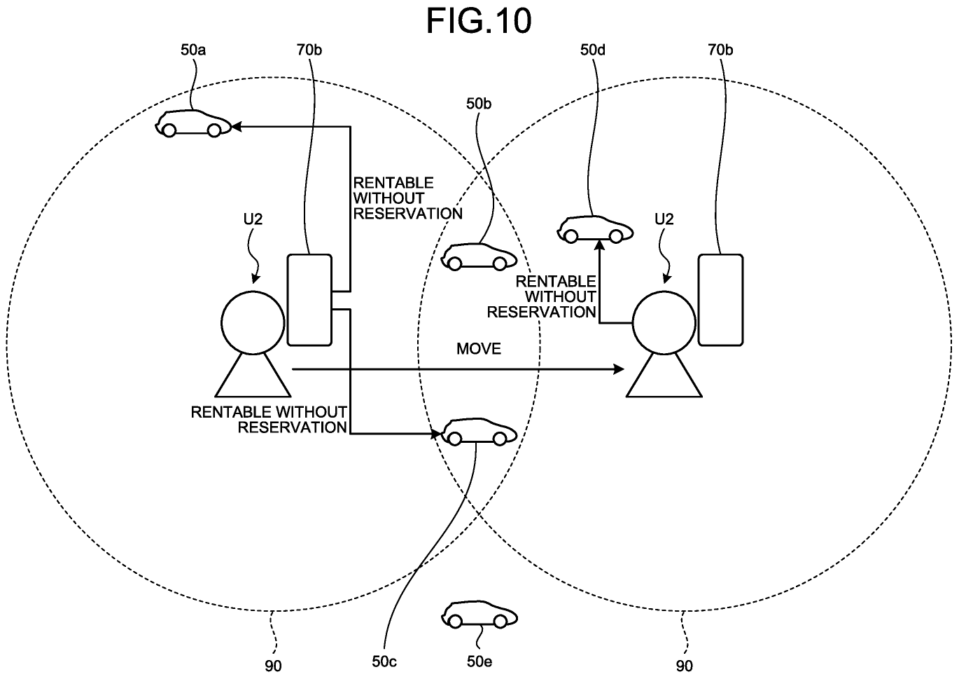

Next, a rental management method according to an exemplary embodiment will be described. FIGS. 9 and 10 are a flow chart and a schematic view, respectively, for explaining the rental management method according to this exemplary embodiment. The following description will be made in accordance with the flow chart in FIG. 9 while referring to FIG. 10 as appropriate.

Specifically, as illustrated in FIGS. 9 and 10, in step ST11, the positional-information judgment unit 25 of the rental management server 20 judges whether or not the service application 75a is in a started state in a user terminal apparatus 70b. If the service application 75a is in the started state in either foreground processing or background processing, information relating to a start is sent from the user terminal apparatus 70b to the rental management server 20. The rental management server 20 repeatedly performs step ST11 while information relating to a start is not received (step ST11: No).

In a case where the positional-information judgment unit 25 receives information relating to a start of the service application 75a in the user terminal apparatus 70b (step ST11: Yes), the process proceeds to step ST12. In step ST12, the credibility-information judgment unit 24 of the rental management server 20 sends a credibility request signal regarding a user U2 to the credit evaluation server 30. The credit evaluation server 30, which receives a credibility request signal, sends credibility information about the user U2 to the rental management server 20. Subsequently, the process proceeds to step ST13, in which the credibility-information judgment unit 24 which receives credibility information in the rental management server 20 judges whether or not credibility of the user U2 is equal to or greater than a prescribed value which is determined previously. If credibility of the user U2 is less than a prescribed value (step ST13: No), the rental management process which is a process of renting out the vehicle 50 is finished.

On the other hand, if credibility of the user U2 is equal to or greater than a prescribed value (step ST13: Yes), the process proceeds to step ST14. In step ST14, the positional-information judgment unit 25 receives current positional information about the user terminal apparatus 70b of the user U2 illustrated in FIG. 10. Subsequently, the process proceeds to step ST15, in which the positional-information judgment unit 25 determines a user-located area 90 using a predetermined range around a current position of the user terminal apparatus 70b, based on current positional information about the user U2. Here, a method for determining the user-located area 90 may possibly be a method in which a circular area which has as its center the user terminal apparatus 70b and has a radius R (km) is used, or a method in which a predetermined administrative district covering a position where the user terminal apparatus 70b is present is used, for example, but is not limited to those examples.

In step ST16, the positional-information judgment unit 25 receives current positional information from each of the vehicles 50a to 50e. Here, the vehicles 50a to 50e are similar to those described in the above. Also, the above-described order of a pair of steps ST14 and ST15, and step ST16 is not limited to any specific order, and those steps may be performed in a reverse order or in parallel. Further, the above-described steps ST12 and ST13 may be performed after any of steps ST14 to ST16, before step ST17. In this case, the process is allowed to proceed to step ST17 only after the rental management server 20 receives credibility of the user U2 and a requirement that the received credibility is equal to or greater than a prescribed value is satisfied (step ST13: Yes).

In step ST17, the positional-information judgment unit 25 judges whether or not at least one vehicle 50 is present in the user-located area 90. If the positional-information judgment unit 25 judges that the vehicle 50 is not present in the user-located area 90 (step ST17: No), the process returns to step ST14, and steps ST14 to ST17 are repeatedly performed. On the other hand, if the positional-information judgment unit 25 judges that the vehicle 50 is present in the user-located area 90 (step ST17: Yes), the process proceeds to step ST18.

In step ST18, the rental-use judgment unit 26 generates an electronic key serving as permission information with which the vehicle 50a which is present in the user-located area 90 illustrated in FIG. 10 and is located closest to the user U2, for example, may be unlocked. It is noted that an electronic key with which all of the vehicles 50a to 50c may be unlocked may be generated. Generation of an electronic key is accomplished in the same manner as in the above-described step ST8 (refer to FIG. 7). Specifically, either electronic keys which respectively match all of the vehicles 50a to 50c present in the user-located area 90, or only one electronic key with which the vehicles 50a to 50c may be unlocked and the vehicles 50d and 50e present outside the user-located area 90 cannot be unlocked, is generated. Thereafter, the process proceeds to step ST19.

Step ST19 is similar to the above-described step ST9 (refer to FIG. 7). Subsequently, in step ST20, the rental-use judgment unit 26 judges whether or not the user U2 starts to rent at least one of the vehicles 50a to 50c in the same manner as in the above-described step ST10 (refer to FIG. 7).

If information relating to a start of rental of the vehicle 50 by the user U2 is not included in vehicular information or user selection information after a predetermined time elapses, the rental-use judgment unit 26 judges that rental of the vehicle 50 is not started (step ST20: No), and the process returns to step ST14. The above-described steps ST14 to ST20 are repeatedly performed at predetermined periods while rental of the vehicle 50 by the user U2 is being suspended.

Here, in a case where the user U2 moves as illustrated in FIG. 10 while all of the vehicles 50 are being left un-rented, the user-located area 90 is newly determined along with movement of the user U2. As a result of this, in an example illustrated in FIG. 10, the vehicles 50 present in the user-located area 90 are switched from the vehicles 50a, 50b, and 50c to the vehicles 50b, 50c, and 50d, due to movement of the user U2.

In this case, in the above-described step ST18, the rental-use judgment unit 26 newly generates an electronic key with which at least one vehicle 50d located closest to the user U2, for example, out of the vehicles 50b to 50d present in the user-located area 90, may be unlocked. It is noted that an electronic key with which all of the vehicles 50b to 50d present in the user-located area 90 may be unlocked, may be newly generated. A method for generating an electronic key is similar to that in the above-described case where an electronic key which matches the vehicles 50a to 50c is generated. Subsequently, in step ST19, the rental-use judgment unit 26 encrypts a generated electronic key, and sends the electronic key to the user terminal apparatus 70b, so that an electronic key stored in the storage unit 75 is updated to a new electronic key.

After that, if information relating a start of rental of the vehicle 50b in the user-located area 90, for example, by the user U2, is included in vehicular information or user selection information which is received by the rental management server 20, the rental-use judgment unit 26 judges that rental of the vehicle 50b is started (step ST20: Yes). When rental of the vehicle 50b, for example, by the user U2 carrying the user terminal apparatus 70b is started, the rental management process in the rental management server 20 is finished.

By the above-described rental management method according to the this exemplary embodiment, the user U2 who has credibility equal to or greater than a prescribed value and carries the user terminal apparatus 70b may rent the vehicle 50 which is located in the user-located area 90 being determined based on a current position of the user U2, and is owned or managed by a car-sharing service company without following various procedures for rental by the user U2 himself. Accordingly, the same effects may be attained by the above-described exemplary embodiments.

A program for performing the rental management method may be recorded on a recording medium which is readable by a computer or the other machines or apparatuses (which will be referred to as a computer and the like). A program in the recording medium is read into a computer or the like and is executed, so that the computer functions as the rental management server 20. Here, a recording medium which is readable by a computer or the like means a non-temporary recording medium in which information such as data or programs is accumulated by an electrical, magnetic, optical, mechanical, or chemical action and is readable via a computer or the like. Among such recording media, recording media which are removable from a computer or the like include a flexible disk, a photomagnetic disk, a CD-ROM, a CD-R/W, a DVD, a BD, a DAT, a magnetic tape, a memory card such as a flash memory, and the like, for example. Also, recording media fixed in a computer or the like include a hard disk, a ROM, and the like. Further, an SSD is available as both of a recording medium removable from a computer or the like, and a recording medium fixed in a computer or the like.

While the exemplary embodiments have been described in detail hereinbefore, the present disclosure is not limited to the above-described exemplary embodiments, and various modifications based on a technical idea are possible. For example, the server configuration provided in the above-described exemplary embodiments is a mere example, and a server configuration different from that may be used as needed.

For example, though the rental management server 20 has been described as an independent server managed by a car-sharing service company in the above exemplary embodiments, the present disclosure is not limited to such configuration. For example, the rental management server 20 may be a server which is managed by a manufacturer of the vehicle 50. Also, the rental management process performed by the rental management server 20 may be shared by a server managed by a manufacturer of the vehicle 50 and a server managed by a car-sharing service company, to be performed.

For example, though the example in which an electronic key is generated by the rental management server 20 or the data server 40 has been provided in the above-described exemplary embodiments, the present disclosure is not limited to that. Specifically, an electronic key may be generated by a server managed by a manufacturer of the vehicle 50, a different server managed by a car-sharing service company, or a server managed by a manufacturer of the key unit 58. In a case where an electronic key is generated by a server managed by a manufacturer of the key unit 58, a request signal for generation of an electronic key is sent from the rental management server 20 to a server of a manufacturer of the key unit 58. The server of the manufacturer, which receives a request signal for generation of an electronic key, generates an electronic key which is encrypted so that the electronic key cannot be decrypted by another server. The server of the manufacturer sends an encrypted electronic key to the user terminal apparatus 70 by way of the rental management server 20.

For example, though the rental management server 20, the credit evaluation server 30, and the data server 40 are formed as servers separate from each other in the above-described exemplary embodiments, those servers may be formed of a single server. Further, two of those servers may be formed of a single server which is separate from the remaining server. More specifically, there may be provided a configuration in which the credit evaluation server 30 and the data server 40 are formed as a single server, a configuration in which the credit evaluation server 30 and the rental management server 20 are formed as a single server, or a configuration in which the rental management server 20 and the data server 40 are formed as a single server.

For example, though the above exemplary embodiments have been described by taking a case where service to be used is a car-sharing service, as an example, any of various kinds of service that utilizes a moving object may be applied. More specifically, service such as ride-sharing service, rent-a-car service, rental service of un-crewed flying object, rental service of camper, or rental service of autonomously-travelling vehicle may be employed. Also, the present disclosure is applicable to bicycle-sharing service, rental service of aircraft, or the like.

For example, in the above-described exemplary embodiments, the rental management server 20 may receive current positional information about the vehicle 50 from the data server 40 which collects positional information about the vehicle 50. Likewise, the rental management server 20 may receive current positional information about the user terminal apparatus 70 from the data server 40 which collects positional information about the user terminal apparatus 70.

Also, in the above-described exemplary embodiment, when the user U1 having credibility equal to or greater than a prescribed value enters the closed area 80 which is determined previously, all of the vehicles 50a to 50d which are owned or managed by a car-sharing service company and are present in the closed area 80 are made rentable by the user U1. However, all of the vehicles 50a to 50d are not necessarily made rentable. For example, in a case where credibility of the user U1 is equal to or greater than a first prescribed value, but is less than a second prescribed value greater than the first prescribed value, types of the vehicles 50 that the user U1 may rent may be limited, or the closed area 80 may be reduced. In other words, a type of the vehicle 50 which is rentable or a size of the closed area 80 may be changed depending on a rank of credibility of the user U1.

Though basic rental fees in car-sharing service are set for each user in the above-described exemplary embodiments, basic rental fees may be set depending on various ranks. Specifically, credibility levels of users are classified as plural ranks, and basic rental fees may be reduced as a rank of credibility becomes higher. Further, rental of the vehicle 50 based on the rental management method according to the above-described exemplary embodiments may be set as additional service (which will be hereinafter referred to as optional service) which may be chosen in car-sharing service so that user may enjoy the foregoing optional service by addition of additional basic fees to basic rental fees, exclusively for a user having credibility equal to or greater than a prescribed value. A user having credibility equal to or greater than a prescribed value is allowed to choose and use the foregoing optional service, with the use of the service application 75a. By this setting, it is possible to invite a user to use service which increases credibility in renting the vehicle 50.

Further, the exemplary embodiments may be combined. Specifically, the user-located area 90 may be newly determined based on current positional information about a user when a current position of a user carrying the user terminal apparatus 70 is in the closed area 80 where service may be provided. In this case, when the vehicle 50 managed by a car-sharing service company is present in an area where the closed area 80 and the user-located area 90 overlap each other, the rental management server 20 or the data server 40 generates an electronic key which matches the vehicle 50, and sends the electronic key to the user terminal apparatus 70. In other words, the rental management server 20 may determine the user-located area 90 using a user's entry into the closed area 80 as a trigger, to make the vehicle 50 in an area where the closed area 80 and the user-located area 90 overlap each other, rentable.

With the rental management apparatus, the rental management method, and the program according to the present disclosure, a credible user having credibility equal to or greater than a prescribed value may receive differentiated service which allows the user to rent a moving object in a predetermined condition without following various procedures for renting the moving object, and so, convenience in service for rental of a moving object may be improved.

A provider of rental service may previously determine an area where a moving object is rentable as a closed area in a predetermined district, so that rental may be accomplished efficiently at a low cost.

A moving object which is rentable may be changed in accordance with a current position of a user, so that convenience in rental service of a moving object to a user may be improved.

The management control unit may receive the positional information about the terminal directly from a positional-information acquisition unit of the terminal, so that another apparatus for acquiring current positional information about the terminal becomes unnecessary, which reduces a cost for the rental management apparatus.

Although the disclosure has been described with respect to exemplary embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A rental management apparatus for managing rental of moving objects capable of establishing communication with an external device, the rental management apparatus comprising
a processor comprising hardware, the processor being configured to:
acquire: credibility information including credibility which is a numerical form of credit of a user carrying a terminal; positional information about the moving objects; and positional information about the terminal; and
transmit, to the terminal, permission information for permitting rental of at least one of the moving objects present in a predetermined area covering a position of the terminal when the credibility included in the credibility information about the user is equal to or greater than a prescribed value and the moving objects are present in the predetermined area.

2. The rental management apparatus according to claim 1, wherein
the predetermined area is a closed area which is determined previously; and
the processor is configured to transmit the permission information to the terminal when the position of the terminal which is acquired is in the closed area.

3. The rental management apparatus according to claim 1, wherein the processor is configured to
determine the predetermined area based on the acquired positional information about the terminal, and
transmit the permission information to the terminal when at least one of the moving objects is present in the predetermined area.

4. The rental management apparatus according to claim 3, wherein the processor is configured to update the predetermined area in accordance with movement of the position of the terminal.

5. The rental management apparatus according to claim 1, wherein the processor is configured to acquire the positional information about the terminal from the terminal.

6. A method of managing rental of moving objects capable of establishing communication with an external device, the method comprising:
acquiring: credibility information including credibility which is a numerical form of credit of a user carrying a terminal; and positional information about the terminal;
reading the credibility information about the user from a memory; and
transmitting, to the terminal, permission information for permitting rental of at least one of the moving objects present in a predetermined area covering a position of the terminal when the credibility included in the read credibility information is equal to or greater than a prescribed value and the moving objects are present in the predetermined area.

7. A non-transitory computer-readable recording medium on which a program for managing rental of moving objects capable of establishing communication with an external device is recorded, the program instructing a processor to execute:
acquiring: credibility information including credibility which is a numerical form of credit of a user carrying a terminal; and positional information about the terminal;
reading the credibility information about the user from a memory; and
transmitting, to the terminal, permission information for permitting rental of at least one of the moving objects present in a predetermined area covering a position of the terminal when the credibility included in the read credibility information is equal to or greater than a prescribed value and the moving objects are present in the predetermined area.
